(19) United States
(12) Patent Application Publication
(10) Pub. No.: US 2007/0062393 A1
(43) Pub. Date: Mar. 22, 2007

(54) Label application device

(75) Inventor: Shintaro Nishizaka, Tokyo (JP)

Correspondence Address: OSTROLENK FABER GERB & SOFFEN, 1180 AVENUE OF THE AMERICAS, NEW YORK, NY, 100368403, US

(73) Assignee: Kabushiki Kaisha Sato

(21) Appl. No.: 11/405,821

(22) Filed: Apr. 18, 2006

Related U.S. Application Data
(60) Provisional application No. 60/717,486, filed on Sep. 15, 2005.

(51) Int. Cl. B41F 1/08

(52) U.S. Cl. 101/288

(57) ABSTRACT

A label application device, which holds a label strip stationary under a rest condition, and prints, advances and separating labels from a backing ship at successive label positions. It holds stationary a backing strip of the label strip and an advancing wheel for the backing trip so that they are not shifted when the backing strip extends out of a housing main body and is cut. A driving mechanism has an stopper operable to hold stationary the rotation of the advancing wheel, which advances the label strip and the backing strip in the advancing direction. The advancing wheel engages the backing strip and advances the strip in accordance with the retraction and the release of a movable lever. The driving mechanism has a stopper which detachably couples on the advancing wheel for being driven by each label pitch, and holds the backing strip stationary not to be transferred in the advancing direction in a rest condition.

### CROSS REFERENCE TO RELATED APPLICATION

This application is based upon and claims priority of U.S. Provisional Application Ser. No. 60/717,486, filed Sep. 15, 2005, incorporated by reference.

### BACKGROUND OF THE INVENTION

1. Field of the Invention

The present invention relates to a label application device that transfers a continuous label strip comprised of a plurality of individual labels tacked on a continuous backing strip. The device further is capable of holding the backing strip stationary and is capable of replacing a label guide mechanism in accordance with the width of the label strip.

2. Description of the Related Art

Conventional label application devices transfer a label strip from a supply thereof through a label path in the main housing body, intermittently at the rate of one label at each operation of the device. The label carries price and other printed information as required. The printed label is separated from the backing strip and then applied to an article.

To transfer the labels and separate them, ordinarily, the label strip or the backing strip thereof is engaged by an advancing wheel that is rotatable. The advancing wheel is intermittently rotated and stopped by each pitch of the label, that is, by a length of one label, upon operation of a movable lever. In this way, the label strip is serially transferred in the advancing direction. Only the backing strip is turned backward around a turning pin, which separates each advanced label from the backing strip.

During a rest condition after a completed label transfer of one label, the label strip and the backing strip should be held stationary. However, when a separated label which protrudes out of the main housing body is applied to the article, the label strip advancing through the main housing body may be drawn by the label being applied. This may cause a shift in the label shift stop position, which may cause problems relating to a print position shift at next printing, relating to transferring or to separating.

A particularly high potential problem is that, if an adhesive providing on the back side of the label is strong or cutting between labels is not sufficient due to the use of strong adhesive, a successive label may be drawn out with the label that is to be applied.

Further, when the backing strip with its long extension out of the main housing body is cut, the backing strip may be drawn out of the main housing body if there is no braking on the advancing wheel, whereby the label strip with the backing strip is drawn in the advancing direction. Further, a shift in the stop position may cause problems relating to a label print position shift at the next printing, in transferring or advancing the label strip and in separating each label from the backing strip.

Still further, a conventional label application device includes a mechanism that adapts to a single width of the label strip, although a width-regulating mechanism or a guide mechanism may be provided. It requires a width-regulating mechanism in accordance with each width of the label strip or the label application device requires a guide mechanism if the label strip with an unconformable width is loaded for use. This leads drawbacks in terms of cost-effectiveness and workability in use.

### SUMMARY OF THE INVENTION

The present invention was developed with an object of resolving the above problems.

An object of the present invention is to provide a label application device that is capable of holding the label strip stationary and holding the backing strip under resting condition after the completion of a transfer operation.

Another object of the present invention is to provide a label application device that is capable of properly printing, transferring and separating successive labels from a label strip stocked in the main housing body.

A further object of the present invention is to provide a label application device that is capable of braking the backing strip and the advancing wheel to avoid a position shift during cutting of the backing strip which is engaged with the advancing wheel when the backing strip extending a distance out of the main housing body is cut there.

A still further object of the present invention is to provide a label application device that is capable of loading label strips of various label widths in a single main housing body.

A still further object of the present invention is to provide a label application device that is capable of properly printing, advancing and separating successive labels of a label strip stocked in the main housing body.

A still further object of the present invention is to provide a label application device capable of holding stationary a label strip stocked in the main housing body so that it will not be shifted by operations including label application.

A still further object of the present invention is to provide a label application device that is capable of loading label strips for various types of label widths on a single main housing body.

A still further object of the present invention is to provide a label application device that is capable of advancing a label strip absolutely and under control.

A still further object of the present invention is to provide a label application device in which a guide mechanism on the device may be replaced in accordance with the width of the label strip.

A still further object of the present invention is to provide a label application device, so that when the label strips for various label widths are loaded in the device, it is capable of switching easily to regulate and guide the different width label strips.

A still further object of the present invention is to provide a label application device that is capable of loading label strips for being various label widths in a single main housing body.

The invention provides a driving mechanism including a stop member which, under resting condition, holds the rotatable advancing wheel stationary and prevents advancing of label strip and its backing strip in the advancing direction.

There is an advancing lever for driving the label strip in the advancing direction and a stopping catcher lever for preventing driving of the label strip in the advancing direction. These are arranged on an advancing arm by which they are detachably engaged with the advancing wheel. The label application device has a main housing body. It advances a label strip comprised of a plurality of labels tacked on a backing strip in the main housing body. Each label is separated from the backing strip and is then applied to an article. The label application device comprises a movable lever for operating the advancing wheel. The wheel engages the backing strip, advances the backing strip in the advancing direction upon the retraction and release of the movable lever. The driving mechanism has a stopper which detachably engages the advancing wheel for driving it by the length of a label each pitch of the label, and which holds the backing strip stationary so as to not transfer the label strip in the advancing direction.

The driving mechanism stopper comprises an advancing arm which is coupled onto the movable lever and moves in a movable range. The movable lever comprises an advancing lever which detachably engages an advancing receiver formed on the advancing wheel and is operable to advance the backing strip in the advancing direction by rotating the advancing wheel. A stopping lever detachably engages a stopping receiver which is formed to face the advancing receiver on the advancing wheel, and holds the backing strip stationary so as not to be advanced in the advancing direction.

The advancing receiver and the stopping receiver are formed on radial ribs which are radially formed on a side face of the advancing wheel.

The advancing arm is capable of moving in a movement range over the advancing wheel and the arm is integral with a movement control plate for guiding the advancing arm.

The advancing arm and the movement control plate are coupled together on the movable lever at an advancing arm axis provided on the movable lever.

The advancing arm comprises a flexible member coupled detachably engaging the advancing receiver and the stopping receiver.

The advancing arm comprises a forcing pointer which detachably contacts a label stopper mechanism that holds the label strip stationary.

A printing mechanism prints a predefined print on the labels. The driving mechanism having a stopper and the advancing wheel are all incorporated in a platen unit having a platen for the printing mechanism.

A separating mechanism separates labels from the backing strip. The driving mechanism having a stopper, together with the advancing wheel are incorporated in the platen unit. The separating mechanism is fitted on the forward end of the platen unit, for passing the label strip thereon.

The advancing arm is rotatably fitted on an advancing arm axis provided on the movable lever. The advancing wheel is rotatable by the advancing arm during the retraction and release of the movable lever. Further, the platen unit is openable and closeable around the advancing arm axis on the main housing body.

The label application device can be implemented in a label print and application device in which the printing mechanism is provided, and also in a type of the device in which the printing mechanism is not provided, but instead in which a preprinted label is separated from the backing strip and applied to the article.

Further, the label application device can be implemented in a device wherein the backing strip engages with the advancing wheel after label separation and thereby the label strip is advanced, and furthermore in a device in which the label strip engages the advancing wheel near the separation of the labels from the backing strip.

The invention provides a label stopper mechanism for holding the label strip stationary in a resting condition. In particular, a label strip is inserted and held between a stop member and a stop lever. The label application device has a main housing body. The device transfers the label strip which is comprised of plural label pieces adhered on the backing strip in the main housing body. The label is separated from the backing strip and is then applied to an article. The label application device comprises a movable lever for operating the advancing wheel. The advancing wheel engages the backing strip and is operable for advancing the backing strip in the advancing direction by retraction and release of the movable lever. The driving mechanism has a stopper which detachably engages the advancing wheel and is being driven by each label and holds the backing strip stationary so that is not advanced in the advancing direction.

The label stopper mechanism comprises the advancing arm, which is coupled on the movable lever and moves over a movable range, and the stop member, which is detachably contacted by a forcing pointer formed on the advancing arm. The stop member is pressed against the label strip and is later released from that pressing. An elastic member biases the stop member in a direction away from the label strip. A stop lever is arranged on the opposite side of the stop member and over the label strip, and presses the label strip against the stop member and releases that pressing.

The stop member comprises a pressure member which presses on the back surface of the backing strip.

The stop lever holds and biases the stop member stationary.

The stop lever is rotatable around a stop lever axis provided on the housing main body. The stop lever further comprises a holding roller capable of holding the label strip by rolling thereon.

A printing mechanism prints a predefined print on the labels. The advancing arm and the stop member together with the advancing wheel are incorporated in a platen unit having a platen for the printing mechanism.

A separating mechanism separates the labels from the backing strip. The advancing arm and the stop member together with the advancing wheel are incorporated in the platen unit for passing the label strip thereon, and the separating mechanism is fitted on the forward end of the platen unit.

The platen unit is openable and closeable on the housing main body around the advancing arm axis and couples the advancing arm on the movable lever.

The label application device can be used in a label printing and application device without having a printing mechanism or in a device without a printing mechanism, but wherein a preprinted label is separated from a backing strip and applying to an article.

Further, the label application device can be used in a device wherein backing strip, after separation of a label, engages an advancing wheel which advances the label strip, and furthermore wherein the label strip engages the advancing wheel near the separation between the labels.

A label guide mechanism on the platen passes the label strip thereon during advancing of the label strip by the advancing wheel. A width guide member regulates in the width direction in accordance with various widths of the label strip. That mechanism is detachably on the platen. The label application device advances a label strip, which comprises a plurality of labels adhered on a backing strip, through the main housing body. The labels are separated from the backing strip and are applied to an article. The label application device comprises the movable lever for operating in the main housing body and the advancing wheel which engages and advances the backing strip in the advancing direction during retraction and release of the movable lever. The platen passes the label strip thereon during advancing by the advancing wheel. The label guide mechanism is arranged on the platen and regulates in the width direction, in accordance with various widths of the label strip.

The label guide mechanism is detachable from the platen. It comprises the width guide member which is replaceable enabling use of a width guide member selected according to the width of the label strip.

The width guide member comprises a width guide base plate extending along the platen, a pair of right and left width guide regulating plates extending to the surface side of the platen from both ends of the width guide base plate, and a pair of right and left width guide knobs extending from both ends of the width guide base plate in the opposite direction of the width regulation.

The width guide regulating plates regulate the width of the guide member and guide the label strip. Those plates include width guide catchers which are detachably attached to platen receivers formed on the both sides of the platen.

A printing mechanism prints a predefined print on the label. The label guide mechanism together with the advancing wheel are incorporated in the platen unit, which includes a platen for the printing mechanism.

A separating mechanism separates the labels from the backing strip. The label guide mechanism together with the advancing wheel are incorporated in the platen unit. The separating mechanism is fitted on the forward end of the platen unit.

An advancing arm or pawl is fitted on the advancing arm axis provided on the movable lever. The advancing wheel is rotated by the advancing arm, which rotation is caused by the retraction and release of the movable lever. Further, the platen unit is openable and closeable around the advancing arm axis on the main housing body.

The driving mechanism has a stop member which, in the resting condition, holds the advancing wheel stationary preventing advancing of the label strip and the backing strip in the advancing direction. This enables a cutting operation cutting off the backing strip part that is then extending out of the main housing body. The backing strip can be held stationary in the stop position without rotation of the advancing wheel in the advancing direction. Therefore, printing, advancing and separating of a next label in series can be performed without a position shift of the label strip or the backing strip resting in the main housing body from each true position.

The label stopper mechanism holds the label strip stationary, so that when the separated labels are applied to an article, the strip or the labels are not drawn forward. In other words, printing, transferring or advancing and separating each label from a next label can be properly performed without a position shift from each true position of the label strip or of the backing strip resting in the main housing body.

Further still, the invention provides a label guide mechanism having a width guide member on a platen for passing the label strip thereon along during advancement of the label strip by the advancing wheel. The width guide member is replaceable and the member is selected according to the width of the label strip. This enables label strips of various label width to be loaded and to be correctly guided, such that a single label application device is available for various label strips.

Other features and advantages of the present invention will become apparent from the following description of the invention which refers to the accompanying drawings

### BRIEF DESCRIPTION OF THE DRAWINGS

FIG. 1 is a sectional side view showing an embodiment of a label application device of the present invention.

FIG. 2 is an exploded perspective view of a platen unit and an advancing and guiding arrangement in the application device.

FIG. 3 is a perspective view of a unit body of the platen unit.

FIG. 4 is a side view of the platen unit 19.

FIG. 5 is a cross-sectional view along a line V-V of FIG. 4, which shows a width guide member before its assembly into the platen unit.

FIG. 6 is the same cross-section view as FIG. 5, which shows the width guide member after its assembly into the platen unit.

FIG. 7 is a sectional side view of the relevant parts from FIG. 2 in a rest state, stopped or waiting.

FIG. 8 is a sectional side view as in FIG. 7, with the movable lever retracted slightly.

FIG. 9 is the same cross-sectional views as in FIG. 8 with the movable lever retracted completely.

### DESCRIPTION OF THE PREFERRED EMBODIMENTS

A driving mechanism having a stop member of the invention prevents the backing strip of the label strip from shifting from a fixed position during a backing strip cutting operation, and the label application device capable of resolving a problem with a print position shift. Further, a label stopper mechanism is provided, so that the label strip is not shifted from its fixed position during application of a label to an article, and the label application device is capable of resolving a problem with the print position shift.

Furthermore, a label guide mechanism, which is selected according to the width of the label strip, is provided on the platen, so that the label application device is capable of loading label strips of various label widths.

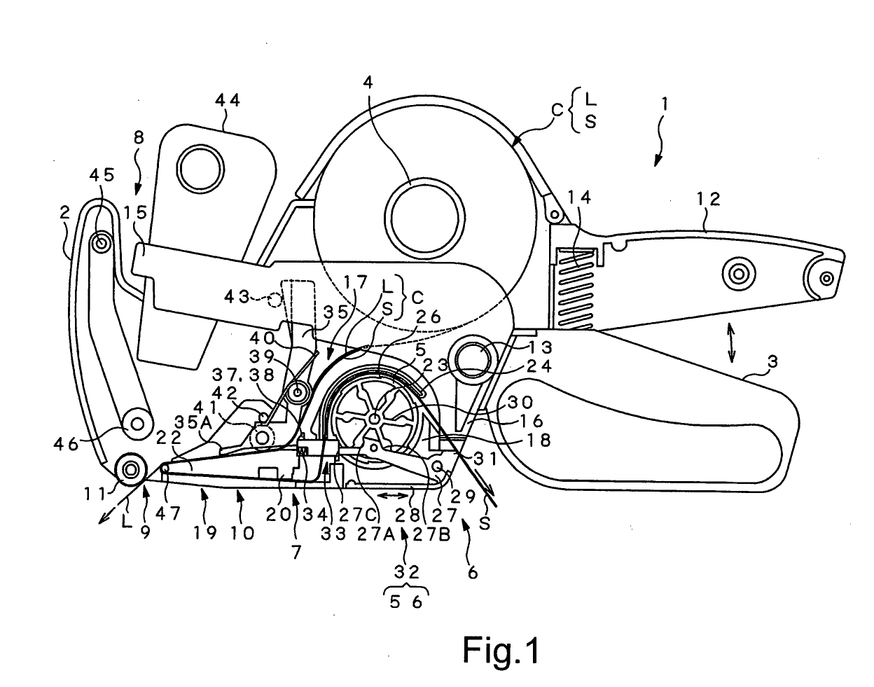

The label application device 1 according to embodiments of the present invention is described with reference to FIG. 1 thru FIG. 9. FIG. 1 is a sectional side view of the label application device 1.

The label application device 1 comprises a main housing body 2, a movable lever 3, a label supply 4, a label strip advancing wheel 5, a driving mechanism having a stopper 6, a label stopper mechanism 7, a printing mechanism 8 or print stamp mechanism, a separating mechanism 9 at which advancing labels are separated from the backing strip, a label guide mechanism 10 and an applying roller 11 for applying the then separated label.

The main housing body 2 is formed by a pair of right and left side plates (around the middle in the Figure) which contains the whole label application device 1 therein, and a grip 12 (to the right and middle side in the Figure) is formed on the upper rear side of the side plates.

The movable lever 3 is rotatable around a movable lever axis 13 and is operable on the housing main body 2 at the grip 12. A movable lever spring 14 is disposed between the movable lever 3 and the grip 12. Operation of the lever 3 in cooperation with the grip 12 causes retraction of the lever and release thereof against the biasing force of the movable lever spring 14. A yoke 15 extends in the direction of the print mechanism 8 and is disposed on the movable lever 3. An arm link 16 extending on the rear side (right side in the Figure) of the advancing wheel 5 is also formed on the movable lever 3.

The label strip C comprises a plurality of label pieces L tacked or adhered onto a backing strip S. The label strip is loaded as a roll on the label supply 4. It is passed from the label supply 4 along a transit route 17 in the housing main body 2.

The transit route 17 follows a course from the label supply 4 outside of the main housing body 2, through the label stopper mechanism 7 and the printing mechanism 8. A separating mechanism 9 folds the backing strip from advancing forward to rearward to be engaged by the advancing wheel 5, so that only the backing strip S is passed out through a gap between the arm link 16 and an exit guide 18.

When the movable lever 3 is retracted, that is pivoted counterclockwise in FIG. 1, the label strip C is printed on a label L by the print mechanism 8. On release of the lever 3, the label strip C is advanced in the advancing direction and the label L is separated from the backing strip S. Further, while the grip 12 and the movable lever 3 are in the released condition, the label application device 1 is brought into contact with the article to be labeled to apply the label by an applying roller 11.

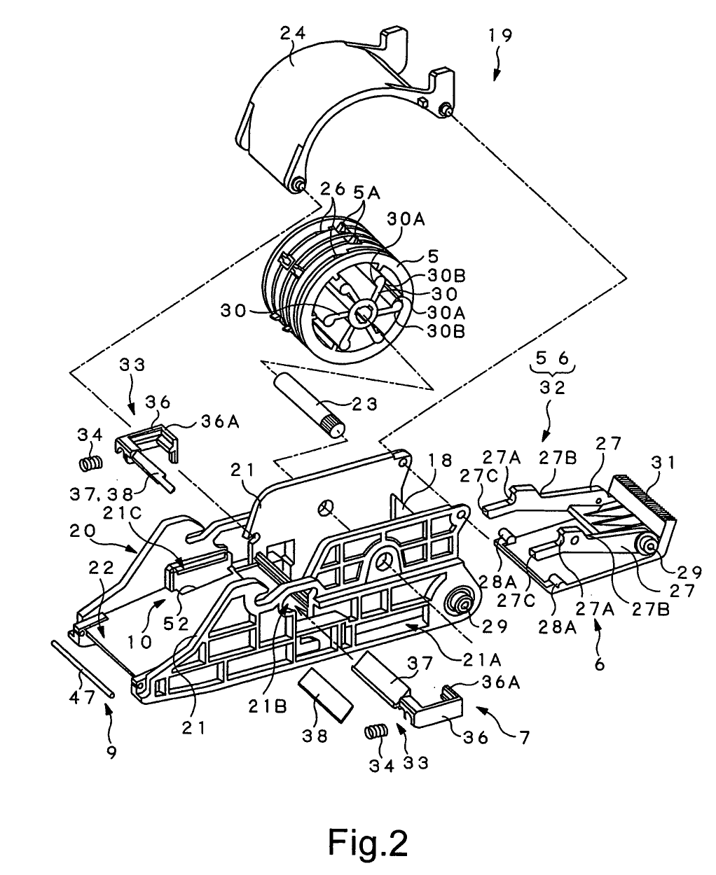

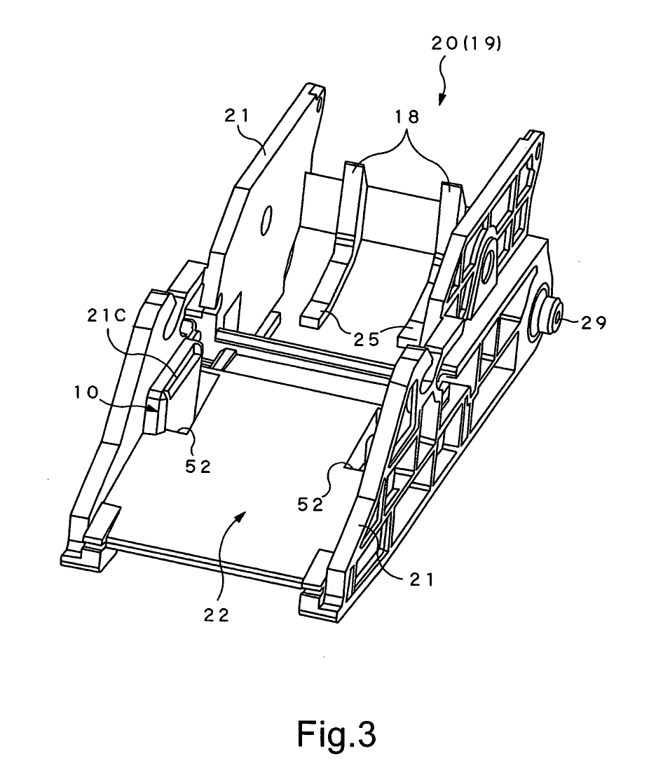

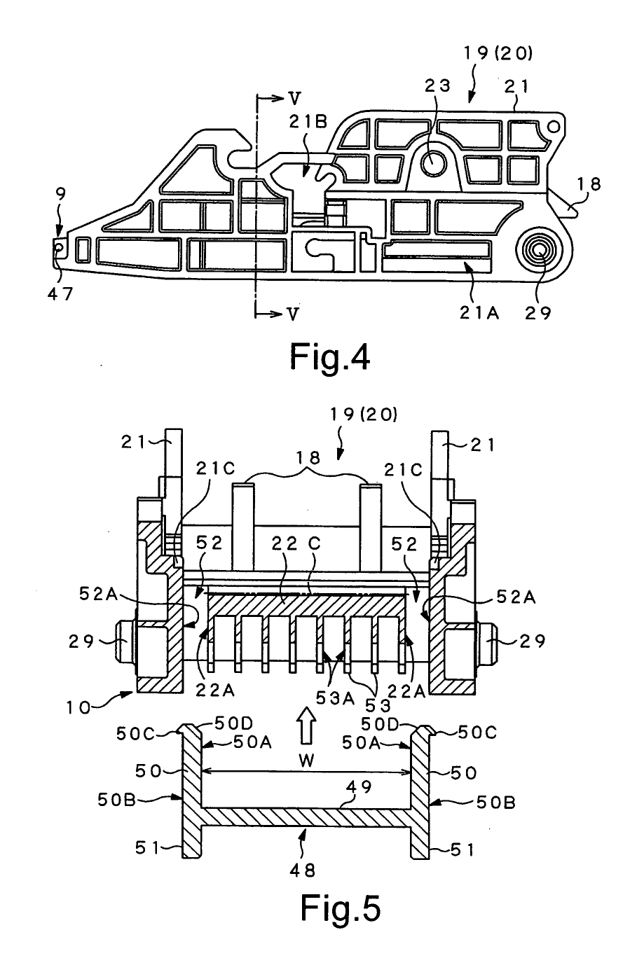

FIG. 2 is an exploded perspective view of the platen unit 19, which includes the advancing wheel 5, the driving mechanism having a stopper 6, part of a label stopper mechanism 7, the separating mechanism 9 and the label guide mechanism 10. FIG. 3 is a perspective view of a unit main body 20 of the platen unit 19. FIG. 4 is the side view of the platen unit 19.

The unit main body 20 of the platen unit 19 integrates a pair of right and left guide brackets 21 along the label strip transit route 17. The platen 22 for the printing mechanism 8 is on the anterior portion in between the guide brackets 21.

The pair of right and left guide brackets 21 supports the advancing wheel 5 which is rotated around a rotary shaft 23. A strip guide cover 24 curved circularly is arranged to cover the upper side of the advancing wheel 5. The backing strip S is passed through between the advancing wheel 5 and the cover 24.

The advancing wheel 5 includes advancing pawls 5A thereon which engage the backing strip S. The pawls 5A are equiangularly arrayed on the circumferential surface in accordance with the pitch of the labels L. The backing strip S of the label strip C is advanced in the advancing direction by the rotation of the wheel 5 which is caused by the retraction and release of the movable lever 3.

In FIG. 3, at the lower part of the unit main body 20, a pair of backstop pawls 25 protrude below the advancing wheel 5. They are serially and detachably engageable with right and left backstop notches 26 which are formed along the circumference of the advancing wheel 5. This prevents the counterrotating or return of the advancing wheel 5 in the upstream direction. Further, the advancing wheel 5 is prevented from rotating and moving the label strip C via backing strip S in the advancing direction (normal rotation) when the movable lever 3 is in the released condition.

The guide bracket 21 (of the unit main body 20) integrates the driving mechanism having a stopper 6 and the label stopper mechanism 7 together.

The driving mechanism having a stopper 6 comprises a pair of right and left advancing arms 27 and the movement control plate 28 which rotates the advancing arm 5 by each pitch of the label, by the detachable engagement of the advancing arms 27 with the advancing wheel 5, and the stopper 6 holds the backing strip S stationary against advancing in the advancing direction.

The advancing arms 27 and the movement control plate 28 are integrally coupled on their fixed end to form a predefined relative angle, wherein the fixed end is coupled on the advancing lever 3 via the advancing arm axis 29 arranged on the forward end of the arm link 16 of the movable lever 3, which moves in a movement range in accordance with their operation.

An advancing pawl or surface 27 A, a stopping pawl or surface 27B and a forcing pointer 27C are formed on the free end portion of the advancing arm 27.

A cooperating respective advancing receiver 30A and stopping receiver 30B are formed on each radial rib 30, and each rib is formed to protrude from each side surface of the advancing wheel 5. Both the advancing receiver 30A and the stopping receiver 30B of the radial ribs 30 for being laid side by side face each corresponding portion of the advancing wheel 5 in the rotating direction.

The advancing pawl or surface 27A detachably pushes the advancing receiver 30A, which thereby rotates the advancing wheel 5 to advance the backing strip S in the advancing direction.

The stopper pawl or surface 27B detachably presses on the stopping receiver 30B, and thereby the backing strip S thereby is held stationary so as not to be advanced in the advancing direction.

The forcing pointer 27C detachably contacts the label stopper mechanism 7 for holding the label strip C stationary. (described hereinbelow)

Furthermore, each advancing arm 27 is comprised of a flexible member, which detachably engages either the advancing receiver 30A or the stopping receiver 30B and moves in a movement range over the advancing wheel 5 and is integral with the movement control plate 28 for guiding the advancing arms 27.

A pair of right and left control projections 28A, which are formed on the free end of the movement control plate 28, engage with control box windows 21A which are formed on the rear bottom of the pair of right and left guide brackets 21S. The movement control plate 28 moves along the control box window 21A in accordance with the operation of the movable lever 3. Further, the advancing arms 27 are integrated together with the movement control plate 28 on the advancing arm axis 29 over a movement range.

In addition, a saw off blade 31 for cutting the backing strip is formed on the rear end of the movement control plate 28.

The transport mechanism 32 for the label strip C (the backing strip S) is formed by the driving mechanism having a stopper 6 and the advancing wheel 5.

The label stopper mechanism 7 advances the label strip C by each pitch of the label L in conjunction with the rotation of the advancing wheel 5, and also holds the strip stationary so that it is not to be advanced in the advancing direction.

The label stopper mechanism 7 comprises the advancing arms 27, the pair of right and left stop members 33, the pair of right and left elastic members 34 (stop lever coil) and the pair of right and left stop levers 35 (FIG. 1)

As shown in FIG. 1 and FIG. 2, the stop member 33 comprises a reciprocable member 36, a pressure plate 37 protruding from the reciprocable member 36 in the direction of the transit route 17 for the label strip C, and the pressure member 38 fixed on the surface of the pressure plate 37.

The reciprocable member 36 is contained together with the elastic member 34 in a fitting window 21B formed on the pair of right and left guide brackets 21. The member 34 is capable of moving such that either the pressure plate 37 (pressure member 38) is separated from the rear surface of the backing strip S of the label strip C by the biasing force of the elastic member 34 or it presses against the label strip C, against a biasing force of the elastic member 34. However, the biasing force of the elastic member 34 is set lower than the force of the movable lever spring 14, such that when the movable lever 3 is not operated, i.e., not retracted the pressure member 38 presses against the rear surface of the backing strip S and the stop lever 35 at the predefined pressure.

A catcher 36A is formed on the rear end of the reciprocable member 36 and is to be flexed to a right angle to the main body thereof. It is detachably contacted by the forcing pointer 27C of the advancing arm 27, which selectively causes the label strip C to be pressed and not pressed.

When the forcing pointer 27C of an advancing arm 27 presses the reciprocable member catcher 36A of the reciprocable member 36 in the direction of the label strip C against the bias force of the elastic member 34, the pressure member 38 of the pressure plate 37 contacts the back surface of the backing strip C at the predefined pressure and then holds the label strip C stationary to be pressed with the stop lever 35 therebetween.

It is preferable that the pressure member 38 be made of rubber material or of another soft member for holding the label strip stationary.

As shown in FIG. 1, the stop lever 35, which is opposite the stop member 33 and over the label strip C, is rotatable around the stop lever axis 39 on the main housing body 2. Further, the stop lever 35 is consistently biased toward the stop member 33 by a stop lever coil or spring 40 to press the label strip C with the stop member 33 therebetween and to release the pressing. Therefore, the label strip C is held stationary, not to be advanced, by the biasing force of the elastic member 34 and the stop lever coil 40 or spring.

Further, the stop lever 35 is comprised of a holding roller 41 which is held down and rotates freely over the label strip C being advanced on the platen 22. The stop lever includes a holding end 35A on the forward end thereof to assure stable transfer of the label strip C on the platen 22 and printing by the printing mechanism 8.

In addition, the stop lever 35 detachably contacts a stop lever coil pin 42 on which one end of the stop lever coil or spring 40 is caught. When the movable lever 3 is not being operated, the stop lever 35 is rotated in clockwise direction around the stop lever axis 39 in FIG. 1 and is held stationary by its contact on the stop lever coil pin 42. This provides a narrow gap between the holding roller 41 and the label strip C on the platen 22.

A stop lever pin 43 in the housing main body 2 prevents the stop lever 35 from rotation counterclockwise beyond a predefined position in accordance with the release of the platen unit 19 (platen 22), as shown in FIG. 1.

The printing mechanism 8 comprises a printing head 44 fitted on the forward end of the yoke portion 15 of the movable lever 3, an ink roller 46 supported on a roller axis 45 of the forward upper end of the housing main body 2 and biased consistently in the direction of the printing head by a predefined elastic member (not shown), and the platen 22.

As the movable lever 3 is retracted, the printing head 44 is inked by the ink roller 46. Then the predefined print on the print head is applied on the label strip C (label L) then on the platen 22.

The separating mechanism 9 includes the turning pin 47 at the forward end of the platen 22. Only the backing strip S is turned back in the direction of the advancing wheel 5 at the turning pin 47. The label L is separated from the backing strip S. The separated label L is applied to a predefined article by the applying roller 11.

The label guide mechanism 10 is arranged on the platen 22 for passing the label strip C thereon, along with the advancing of the label strip C by the advancing wheel 5. The mechanism 10 is capable of adjustment in the width direction according to various widths for the label strip C.

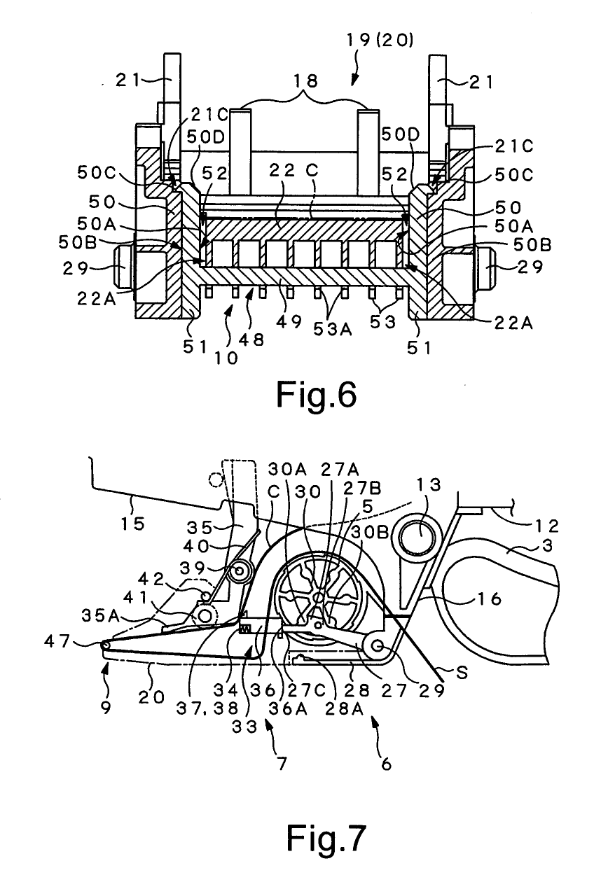

FIG. 5 and FIG. 6 are both cross-sectional views along the line V-V of FIG. 4. The label guide mechanism 10 is detachable from the platen 22 (platen unit 19) and comprises a width guide member 48 which may be changed according to the width of the label strip C. FIG. 5 shows the width guide member 48 before it is incorporated into the platen unit 19 (unit main body 20) while FIG. 6 shows it after assembling thereof.

The width guide member 48, as seen in FIG. 5, has an H shape in cross section view. It extends a predefined length in the advancing direction of the label strip C. It comprises a width guide base plate 49 that extends along the width direction on the lower side of the platen 22. A pair of right and left width guide regulating plates 50 extend from both ends of the width guide base plate 49 to the surface side of the platen 22. A pair of right and left width guide knobs 51 extend from both ends of the width guide base plate 49 in the opposite vertical direction from the width guide regulating plates 50.

The pair of right and left width guide regulating plates 50 are regulated to the width of the label strip C by corresponding the distance between both regulating plate insides 50A and this properly guides the label strip C. In other words, a plurality of width guide members 48 having different widths W between the pair of right and left regulating plate insides 50A are provided in accordance with various widths for the label strip C.

The width guide regulating plates 50 are inserted, linked and fixed in a width guide slot 52 which enters deeply between both outside of the platen 22 and the guide bracket 21. Each regulating plate outside 50B of the pair of right and left width guide regulating plates 50 includes a width guide knob 51 that links along each guide slot outside 52A on the guide bracket 21 side of the width guide slot 52. (FIG. 6) In addition, the width guide regulating plate 50 has a width guide catcher 50C which detachably engages the platen side receiver 21C formed on each guide bracket 21 of the platen 22.

Further, in as shown in FIG. 6, even with the width guide regulating plate 50 of the width guide member 48 inserted and linked, the predefined narrow gap is provided for the width guide slot 52 between the regulating plate inside 50A and a regulating plate outside of the platen 22A. Various width guide members 48, with different thicknesses of the width guide regulating plate 50 (thickness in the width direction of the label strip C) as for thickness in the width direction) are available. Therefore, easy attachment and detachment of the width guide member 48 to or from the width guide slot 52 is made.

Further, an inwardly tapered surface 50D is formed on the width guide catcher 50C, to easily guide the label strip C against the platen 22 with loading thereof and the width guide regulating plate 50 is easily inserted into the width guide slot 52.

A plurality of vertical ribs 53 are formed on the underside of the platen 22 in the direction of the width guide base plate 49 of the width guide member 48. The width guide base plate 49 is engageable with an engageable recess 53A formed on the front side of each vertical rib 53 from the lower side of the platen 22. This aids in fitting the width guide member 48 on the platen 22 and assures the engagement between the platen side receiver 21C and the width guide catcher 50C.

The driving mechanism having a stopper 6, the separating mechanism 9, the label guide mechanism 10, the advancing arm 27, the stop member 33 and the advancing wheel 5 are all incorporated in the platen unit 19.

Further, the entire platen unit 19 is openable and closeable on the main housing body 2 around the advancing arm axis 29 at which the advancing arm 27 is pivoted on the movable lever 3. This enables loading of the label strip C on the main housing body 2.

The operations of printing on the label strip C (labels L), advancing the label strip and separating the labels in accordance with the retraction and the release of the movable lever 3 against the grip 12, and further about the movement for the driving mechanism having a stopper 6, the label stopper mechanism 7 and the label guide mechanism 10 are next described based on the label application device 1 having this structure.

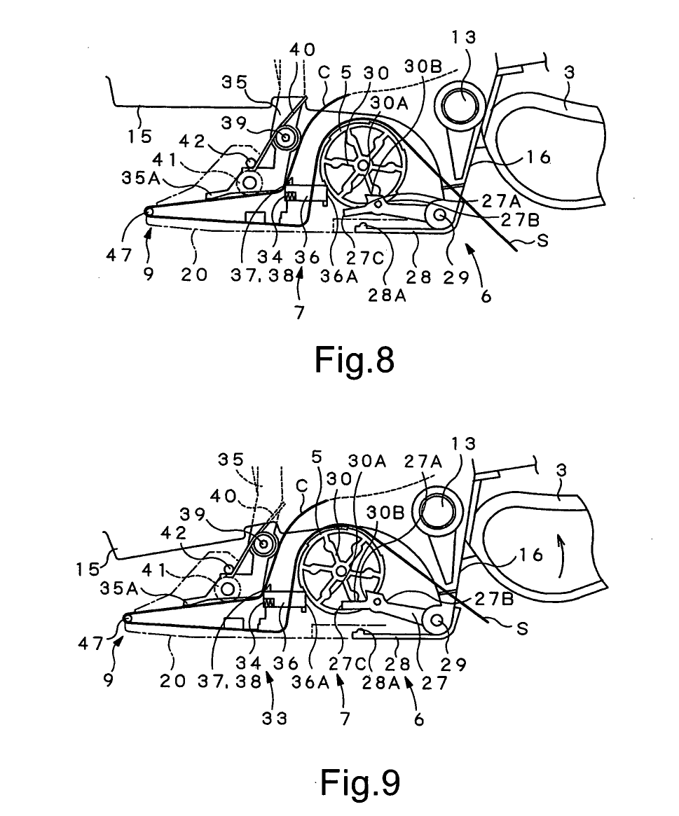

FIG. 7 is a sectional side view of the relevant part of the labeler when the movable lever 3 is released, FIG. 8 is a sectional side view when the movable lever 3 is slightly retracted, and FIG. 9 is the view when the movable lever 3 is completely retracted.

As shown in FIG. 7 and in FIG. 1, when the movable lever 3 is in a released state, the advancing arm 27 of the driving mechanism having a stopper 6 engages the radial rib 30 (the advancing receiver 30A) of the advancing wheel 5 and also engages the reciprocable member 36 of the label stopper mechanism 7 by the biasing force of the movable lever spring 14 acting through the movable lever 3 and the arm link 16.

In other words, the forward, advancing surface 27A of the advancing arm 27 engages the advancing receiver 30A of the radial rib 30 of the advancing wheel 5. At the same time, the rearward stopping surface 27B engages the stopping receiver 30B of the radial rib 30. The advancing wheel 5 is thereby prevented from rotating in the advancing direction. Further, the backing strip S is not pulled out of the label application device 1 (housing main body 2) when the backing strip S is cut at the saw off blade 31, and the label strip C is held stationary, not to be shifted. This avoids problems relating to the printing, advancing and separating during the next retracting operation of the movable lever 3.

Further, the forcing tip 27C of the advancing arm 27 contacts the reciprocable member 36 (at the reciprocable member surface 36A) of the stop member 33. This presses the entire stop member 33 on the label strip C forward, in the direction of the stop lever 35, and over the label strip C and acts against the biasing force of the elastic member 34. This holds the label strip C stationary at a predefined position of the platen 22.

As shown in FIG. 8, when the movable lever 3 is retracted slightly, the advancing arm 27 of the driving mechanism having a stopper 6 and the movement control plate 28 are pulled back together by the arm link 16 through the advancing arm axis 29. Then the advancing arm 27 rotates to be slightly bent around the advancing arm axis 29. The advancing surface 27A is disengaged from the advancing receiver 30A of the radial rib 30, and the stopping surface 27B is disengaged from the stopping receiver 30B of the radial rib 30, so that the advancing arm 27 is disengaged from the advancing wheel 5.

In addition, the movement control plate 28 moves along the control box window 21A under control by the periphery of the window and holds the advancing arm 27 to the predefined position.

Further, the forcing pointer 27C of the advancing arm 27 moves away from the reciprocable member surface 36A of the reciprocable member 36 of the stop member 33 for the label stopper mechanism 7. Further, the reciprocable member 36 enables the pressure plate 37 to be moved away from the rear surface of the backing strip S of the label strip C under the biasing force of the elastic member 34. This releases braking of the label strip C due to holding between the pressure member 38 and the stop lever 35, and the label strip can be advanced.

Upon release of engagement of the stop lever 35 from the stop member 33 over the label strip C, the stop lever 35 is rotated slightly counterclockwise by the biasing force of the stop lever coil or spring 40 around the stop lever axis 39. This causes the holding roller 41 of the stop lever 35 to contact the surface of the label strip C at the predefined pressure and to press the label strip in the direction of the platen 22. The holding roller 41 is rotatable on the label strip C during advancement of the label strip C.

As shown in FIG. 9, when the movable lever 3 is completely retracted against the grip 12, the advancing arm 27 and the moving control plate 28 are moved further toward the rear portion, and the advancing surface 27A of the advancing arm 27 is in position to engage the advancing receiver 30A of the radial rib 30 which is adjacent to the counterclockwise side of the radial rib 30. Further, the stopping surface 27B of the advancing arm 27 is in position to engage the stopping surface 30B of the radial rib 30. This prepares for advancing the label strip C upon release of the movable lever 3.

When the movable lever 3 is released to move away from the grip 12, the label application device 1 returns to the condition shown in FIG. 1 or FIG. 7. During that return movement, the advancing surface 27A and the stopping surface 27B of the advancing arm 27 respectively engage the advancing receiver 30A and the stopping receiver 30B of the radial rib 30 for being laid adjacent to the radial rib 30 (in counterclockwise direction) of the advancing wheel 5 which was engaged last time (under resting state). Further, the advancing wheel 5 is rotated slightly in the clockwise direction, in the advancing direction over the predefined circumferential angle, (a label pitch of the label L).

The backing strip S of the label strip C is advanced in the advancing direction. When the advancing arm 27 and the movement control plate 28 are in the normal position shown in FIG. 1 or FIG. 7, the stopping surface 27B engages the stopping receiver 30B even if the advancing surface 27A of the advancing arm 27 engages with the advancing receiver 30A of the radial rib 30. This restricts rotation of the advancing wheel 5 in the advancing direction. Even if the backing strip S is cut at the saw off blade 31, the backing strip S is not pulled in the advancing direction. In other words, the whole label strip C is restricted against advancing in the advancing direction, and problems, such as the print position shift described above, may not arise.

In association with the return of the advancing arm 27 to normal position against the advancing wheel 5, the forcing pointer 27C of the advancing arm 27 contacts the reciprocable member 36 (the rear and contact against advancing surface 36A) of the stop member 33, the entire stop member 33 is pressed on the label strip C in the direction of the stop lever 35 over the label strip C against the bias by the elastic member 34. This holds the label strip C stationary at the predefined position of the platen 22. Therefore, problems, such as a print position shift, can be avoided by the label stopper mechanism 7 as well as by the driving mechanism having a stopper 6. In particular, even if a strong connection is provided between the labels L of the label strip C, a successive label L is not pulled on the forward of the platen 22, so that the label stop position shift can be avoided.

Movement of the label guide mechanism 10 is described with reference to FIG. 5 or FIG. 6.

When a label strip C (label L) having a different width than a previous label strip is loaded on the label application device 1 (the label supply 4), the width guide catcher 50C of the width guide regulating plate 50 of the width guide member 48 is removed from the platen side receiver 21C of the guide bracket 21 of the width guide member 48. The width guide base plate 49 of the width guide member 48 is removed from the recesses 53A of the vertical rib 53 below the platen 22, and the width guide member 48 is removed from the platen 22 (the platen unit 19) by sliding the width guide regulating plate 50 along the width guide slot 52.

As shown in FIG. 5, another width guide member 48 having a width W between the pair of right and left width guide regulating plates 50 corresponding to the width of the another label strip C is inserted into the width guide slot 52 from the lower side of the platen unit 19 (platen 22). The width guide catcher 50C of the width guide regulating plate 50 engages with the platen side receiver 21C of the guide bracket 21. Further, the width guide base plate 49 engages in the recesses 53A of the vertical rib 53. The width guide member 48 is fixed on the lower side of the platen 22. Appropriate width regulation of another label strip C and its guidance are provided by the regulating plate inside 50A of the other width guide member 50.

Therefore, the single label application device 1 is capable of adapting to various widths of the label strip C, and operating for printing, advancing, separating and applying is accomplished thereon.

Further, since various widths of label strips C are loadable on the single label application device 1, an optional number of lines for the printing device 44 can be selectively provided for the single housing main body 2 (the yoke 15 of the movable lever 3) according to whether the width of the label strip C is narrow or wide, for example one line of type for printing one line and two line type for printing two lines.

In addition as described above, the advancing wheel 5, the driving mechanism having a stopper 6, the label stopper mechanism 7 or the part thereof, the separating mechanism 9 and the label guide mechanism 10 are all incorporated in the platen unit 19, so that when the platen unit 19 is rotated around the advancing arm axis 29 to open the platen unit, loading of the label strip C on the transit route 17, maintenance and any other operations can be easily performed. Further, the required constructional element can be incorporated to simplify the mechanism.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A label application device comprising:
a main housing body including elements for supporting a label strip comprising a plurality of labels on a backing strip which passes through the body;
an advancing apparatus at the body operable for advancing the label strip through the body from a label strip supply toward an exit from the body;
a separator positioned toward the exit from the body and operable for separating individual labels from the backing strip,
the advancing apparatus comprising:
a movable lever at the body and operable for operating the advancing apparatus;
an advancing wheel shaped and positioned for engaging the backing strip after labels have been separated therefrom, wherein the advancing wheel is rotatable for advancing the backing strip in an advancing direction, the movable lever being connected with the advancing wheel such that the lever rotates the advancing wheel upon retraction and release of the movable lever; and
a driving mechanism having a stopper, the stopper detachably couples on the advancing wheel after the wheel has been driven by each pitch of the label, for holding stationary the backing strip so that it is not advanced in the advancing direction.

2. The label application device according to claim 1, wherein the advancing wheel has advancing receivers and also has stopping receivers formed on the advancing wheel;
the driving mechanism stopper comprises an advancing arm, coupled to the movable lever and operable for moving the advancing arm in a movement range, wherein the advancing arm comprises:
an advancing surface, which detachably engages on one of the advancing receivers, as the movable lever is released for advancing the backing strip in the advancing direction; and
a stopping surface, which detachably engages on one of the stopping receivers formed on the advancing wheel to hold the backing strip stationary and not to be advanced in the advancing direction.

3. The label application device according to claim 2, further comprising a radial support formed at the side of the advancing wheel, and the advancing receiver and the stopping receiver are formed on the radial support.

4. The label application device according to claim 2, wherein the advancing arm moves in a movement range over the advancing wheel, and the advancing arm is attached to a movement control plate controllable in the main housing body for guiding the advancing arm.

5. The label application device according to claim 4, wherein the advancing arm and the movement control plate are coupled together on the movable lever at an advancing arm axis provided on the movable lever.

6. The label application device according to claim 2, wherein the advancing arm comprises a flexible member which detachably couples on the advancing receiver and the stopping receiver.

7. The label application device according to claim 2, further comprising a label stopper operable for holding the label strip stationary; and
the advancing arm comprises a forcing pointer which detachably contacts the label stopper to urge the stopper to a position to hold the label strip stationary.

8. The label application device according to claim 1, further comprising:
a printing mechanism for printing a predefined print on a label, the printing mechanism including a platen unit including a platen for printing mechanism, and
the driving mechanism and the advancing wheel are in the platen unit having the platen.

9. The label application device according to claim 1, further comprising:
a separating mechanism operable for separating each label from the backing strip as the label strip advances past the separating mechanism, and
the driving mechanism and the advancing wheel are in a platen unit for passing the label strip thereon, the platen unit having a forward end, and the separating mechanism is fitted on the forward end of the platen unit.

10. The label application device according to claim 8, wherein the advancing arm is pivotable on an advancing arm axis on the movable lever, the advancing wheel is rotated by the advancing arm, the advancing arm is moved by the retraction and the release of the movable lever, and
the platen unit is openable and closeable around the advancing arm axis on the housing main body.

11. A label application device comprising:
a main housing body including elements for supporting a label strip comprising a plurality of labels on a backing strip which passes through the body;
an advancing apparatus at the body operable for advancing the label strip through the body from a label strip supply toward an exit from the body;
a separator positioned toward the exit from the body and operable for separating individual labels from the backing strip,
the advancing apparatus comprising:
a movable lever at the body and operable for operating the advancing apparatus;
an advancing wheel shaped and positioned for engaging the backing strip after labels have been separated therefrom, wherein the advancing wheel is rotatable for advancing the backing strip in an advancing direction, the movable lever being connected with the advancing wheel such that the lever rotates the advancing wheel upon retraction and release of the movable lever; and
a label stopper mechanism including elements for advancing the label strip by each pitch of a label caused by rotation of the advancing wheel, and elements for holding the label strip stationary not to be advanced in the advancing direction.

12. The label application device according to claim 11, wherein the label stopper mechanism comprises:
an advancing arm coupled on the movable lever to be moved by the lever in a movement range; a forcing pointer on the advancing arm;
a stop member positioned to be detachably contacted by the forcing pointer on the advancing arm, the stop is operable to be selectively pressed against the label strip and to release the press;
an elastic member disposed for biasing the stop member in a direction away from the label strip to release the press; and
a stop lever arranged opposing the stop member over the label strip, the stop lever is selectively pressed against the label strip with the stop member therebetween and releasing the press.

13. The label application device according to claim 12, wherein the stop member comprises a pressure member operable to press against the back surface of the backing strip.

14. The label application device according to claim 12, wherein the stop lever applies a stationary bias against the stop member.

15. The label application device according to claim 12, wherein the stop lever is rotatable around a stop lever axis on the main housing body, and comprises a holding roller operable for holding the label strip by rolling thereon.

16. The label application device according to claim 12, further comprising a printing mechanism for printing a print on the labels, a platen for having the label printed thereon by the printing mechanism; and
the advancing arm, the stop member and the advancing wheel are incorporated in a platen unit including a platen for a label printing mechanism.

17. The label application device according to claim 12, further comprising a printing platen on which labels are printed;
a separating mechanism for separating each label from the backing strip after the labels are advanced past the printing platen;
the advancing arm, the stop member and the advancing wheel are incorporated in a platen unit, and the separating mechanism is fitted on a forward end of the platen, for passing the label strip on the platen.

18. The label application device according to claim 16, wherein the platen unit is openable and closeable on the housing main body around the advancing arm axis for coupling the advancing arm on the movable lever.

19. A label application device, comprising:
a main housing body, including elements in the housing main body for supporting and for advancing a label strip comprising plural pieces of label tacked on a backing strip, and a device operable for separating each label from the backing strip and applying the label to an article,
the label application device comprising:
a movable lever for operating at the housing main body; and
an advancing wheel shaped and positioned for engaging the backing strip, which advances the backing strip in the advancing direction in accordance with retraction and release of the movable lever; and
a platen, on which the label strip is passed by advancing of the label strip caused by the advancing wheel; and
a label guide mechanism arranged on the platen shaped and operable for regulating based on various widths of the label strip.

20. The label application device according to claim 19, wherein the label guide mechanism is detachable from the platen and comprises a width guide member which is replaceable.

21. The label application device according to claim 20, wherein the width guide member comprises:
a width guide base plate extending along the platen; and
a pair of right and left width guide regulating plates extending from both ends of the width guide base plate to a surface of the platen and positioned for guiding the label strip; and
a pair of right and left width guide knobs extending from the width guide base plate in the opposite direction of extension of the width guide regulating plates from the platen.

22. The label application device according to claim 21, wherein the width guide regulating plates include platen receivers formed on the both sides of the platen, and the width guide surfaces are attachable to and detachable from the platen.

23. The label application device according to claim 19, further comprising a printing mechanism for printing a print on the label, and the label guide mechanism together with the advancing wheel are incorporated in a platen unit which includes the platen for the printing mechanism.

24. The label application device according to claim 23, further comprising a separating mechanism for separating the labels from the backing strip after printing thereof;
the label guide mechanism and the advancing wheel are incorporated in the platen unit, the separating mechanism is fitted on the forward end of the platen unit, for passing the label strip thereon.

25. The label application device according to claim 23, further comprising an
advancing arm on an advancing arm axis on the movable lever, and the advancing wheel and the advancing arm are positioned so that the advancing wheel is rotatable by the advancing arm which is caused by retraction and release of the movable lever; and
the platen unit is openable and closeable around the advancing arm axis on the movable lever.
